(19) United States
(12) Patent Application Publication
(10) Pub. No.: US 2026/0037238 A1
(43) Pub. Date: Feb. 5, 2026

(54) COMPILING MACHINE LEARNING SOFTWARE FOR EXECUTION AT EDGE DEVICES

(71) Applicant: EdgeImpulse Inc., San Diego, CA (US)

(72) Inventors: Mathijs Iskander BAAIJENS, Utrecht (NL); Johannes JONGBOOM, Amsterdam (NL)

(21) Appl. No.: 19/277,216

(22) Filed: Jul. 22, 2025

Related U.S. Application Data
(60) Provisional application No. 63/678,386, filed on Aug. 1, 2024.

(51) Int. Cl. G06F 8/41

(52) U.S. Cl. CPC G06F 8/41

(57) ABSTRACT

In some aspects, a processor of one or more computing machines obtains a compute graph associated with a machine learning model. The processor determines, based on the compute graph, a memory allocation scheme associated with a configuration for executing the machine learning model on an edge device. The processor compiles the machine learning model to generate a compiled machine learning model. The processor may compile the machine learning model based on the memory allocation scheme.

### CROSS REFERENCE TO RELATED APPLICATIONS

This application claims priority to U.S. Provisional Application No. 63/678,386, filed Aug. 1, 2024, the content of which is incorporated herein by reference in its entirety for all purposes.

### TECHNICAL FIELD

This disclosure relates generally to machine learning models. For example, some aspects of the present disclosure include systems and techniques for compiling machine learning software for execution at edge devices.

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A machine learning model may be built for a system based on training data (e.g., a dataset). The machine learning model may then be deployed to make predictions (e.g., predictions that an application can use to help guide decisions, such as predictions for image or sound classification), to generate data, and/or to transform data. Machine learning inference technology may be executed on edge devices-thin devices with limited processing hardware, memory hardware, battery power, and/or network interface capabilities.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, the an apparatus for deploying machine learning models is provided, including: at least one memory; and at least one processor coupled to the at least one memory and configured to: obtain a compute graph associated with a machine learning model; determine, based on the compute graph, a memory allocation scheme associated with a configuration for executing the machine learning model on an edge device; and compile, based on the memory allocation scheme, the machine learning model to generate a compiled machine learning model.

In some aspects, the a method is provided, including: obtaining, by a processor, a compute graph associated with a machine learning model; determining, by the processor and based on the compute graph, a memory allocation scheme associated with a configuration for executing the machine learning model on an edge device; and compiling, by the processor and based on the memory allocation scheme, the machine learning model to generate a compiled machine learning model.

In some aspects, a computer-readable medium having instructions stored thereon is provided. When executed by one or more processors, the instructions, cause the one or more processors to: obtain a compute graph associated with a machine learning model; determine, based on the compute graph, a memory allocation scheme associated with a configuration for executing the machine learning model on an edge device; and compile, based on the memory allocation scheme, the machine learning model to generate a compiled machine learning model.

In some aspects, the a means is provided for: obtaining, by a processor, a compute graph associated with a machine learning model; determining, by the processor and based on the compute graph, a memory allocation scheme associated with a configuration for executing the machine learning model on an edge device; and compiling, by the processor and based on the memory allocation scheme, the machine learning model to generate a compiled machine learning model.

In some aspects, one or more of the apparatuses described herein is, is part of, and/or includes a mobile device (e.g., a mobile telephone or other mobile devices) or other wireless communication device, a vehicle or a computing device or component of a vehicle, an extended reality (XR) device or system (e.g., a virtual reality (VR) device, an augmented reality (AR) device, or a mixed reality (MR) device), a wearable device, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 illustrates the training and use of a machine-learning program, in accordance with aspects of the present disclosure.

FIG. 2 illustrates an example neural network, in accordance with aspects of the present disclosure.

FIG. 3 illustrates the training of an image recognition machine learning program, in accordance with aspects of the present disclosure.

FIG. 4 illustrates a convolutional neural network, in accordance with aspects of the present disclosure.

FIG. 5 is a block diagram of a computing machine, in accordance with aspects of the present disclosure.

FIG. 6 is a block diagram of a machine learning pipeline, in accordance with aspects of the present disclosure.

FIG. 7 is a block diagram illustrating an example of a system including a deployment service of a machine learning pipeline, in accordance with aspects of the present disclosure.

FIG. 8 illustrates an example of a compute graph, in accordance with aspects of the present disclosure.

FIG. 9A illustrates another example of a compute graph associated with a machine learning model, in accordance with aspects of the present disclosure.

FIG. 9B illustrates a compute graph that is a modified rendition of the compute graph illustrated in FIG. 9A, in accordance with aspects of the present disclosure.

FIG. 10 illustrates an example of an edge device configured to perform machine learning inference, in accordance with aspects of the present disclosure.

FIG. 11 illustrates an example of a computing machine configured to compile a machine learning model, in accordance with aspects of the present disclosure.

FIG. 12 is a flowchart of an example technique for compiling a machine learning model, in accordance with aspects of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning (ML) is a branch of artificial intelligence (AI) and computer science that focuses on developing algorithms and programs that can iteratively improve based on data. ML specifically focuses on building systems that can adapt and refine their performance over time through exposure to data. AI can be compared to human intelligence in terms of problem-solving, goal-setting, analytical reasoning, communication, collaboration, and self-awareness (consciousness). AI refers to the capability of machines to simulate human intelligence. Unlike humans, AI operates based on predefined rules and does not require elements such as emotions or consciousness for functionality.

Both AI and ML are subsets of data science, which involves applying the scientific method to extract insights from data for decision-making or predictions. For example, an investment banker might analyze stock trends to determine optimal times for buying and selling securities, whereas a software engineer might create a computer vision model for automobile recognition in images. ML involves a focus on designing algorithms (also referred to as “tools”) and systems that autonomously improve through data exposure. Such machine-learning tools operate by building a model from example training data to make data-driven predictions or decisions expressed as outputs or assessments. Often, these algorithms include the creation of mathematical and statistical models trained on input data. These models identify patterns within the input data to formulate rules for making decisions and predictions. Deep learning, as a subset of ML, involves complex models capable of learning hierarchical representations from data through multiple layers.

Machine learning can be broadly classified into supervised learning, unsupervised learning, and reinforcement learning. Supervised learning involves discovering a function (or mathematical model) that maps input data to an output, such as a predicted value or classification. Supervised learning requires labeled data during the training phase, typically annotated by humans. Supervised learning can be further subdivided into regression and classification. In regression, the model predicts continuous values, such as forecasting a house's price based on factors like livable area, location, and size. Classification involves predicting which category the input data belongs to among discrete classes. Unsupervised learning aims to detect patterns in data without ground-truth labels. Examples include clustering, outlier (anomaly) detection, and segmentation. Reinforcement learning focuses on models that learn a policy for selecting actions based on input. These models aim to achieve objectives through trial-and-error interaction with the environment. Other ML categories, such as semi-supervised learning, exist and often involve combinations of the primary three categories.

As discussed above, edge devices may have limited processing hardware, memory hardware, battery power, and/or network interface capabilities. Due to the limited memory resources of edge devices, memory planning while compiling machine learning inference software for execution at edge devices may be desirable. For example, certain types of models or implementations of models may require large amounts of memory at inference time, for example, for intermediate calculations. In some cases, such memory pressure can be particularly acute, especially early in the inference process. For instance, certain inputs such as images may be represented by large amounts of data. Such constraints can make implementation on edge devices challenging.

Systems, apparatuses, processes (also referred to as methods), and computer-readable media (collectively referred to as “systems and techniques”) are described herein for compiling machine learning software for execution, in particular for execution on edge devices. As discussed, edge devices may have lower available resources (e.g., computational resources and/or memory). Accordingly, a reduction in required resources can enable improved and/or new applications using machine learning on edge devices.

In an example, systems and techniques involve obtaining a compute graph associated with a machine learning model, which may be based on a particular model used. Systems and techniques may further involve determining, based on the compute graph, a memory allocation scheme for the model. The memory allocation scheme assists with minimizing an amount of memory, particularly random-access memory (RAM), required at inference time.

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

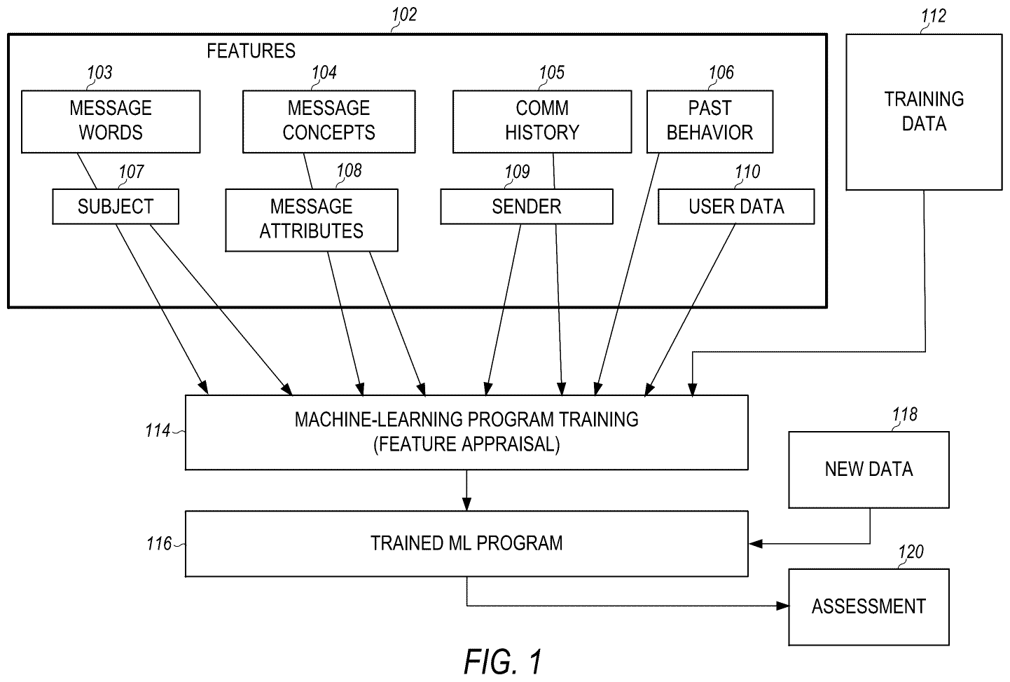

FIG. 1 illustrates the training and use of a machine-learning program, according to aspects of the present disclosure. In some examples, machine-learning programs (MLPs), also referred to as machine-learning algorithms or tools, are utilized to perform operations associated with machine learning tasks, such as image recognition or machine translation. Although examples are presented with respect to a few machine-learning tools, the principles presented herein may be applied to other machine-learning tools. In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In some examples, the features 102 may be of different types and may include words of the message 103, message concepts 104, communication history 105, past user behavior 106, subject of the message 107, other message attributes 108, sender 109, user data 110, any combination thereof, and/or other types.

The machine-learning algorithms utilize the training data 112 to find correlations among the identified features 102 that affect the outcome or assessment 120. In some examples, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model that satisfies the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In examples, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

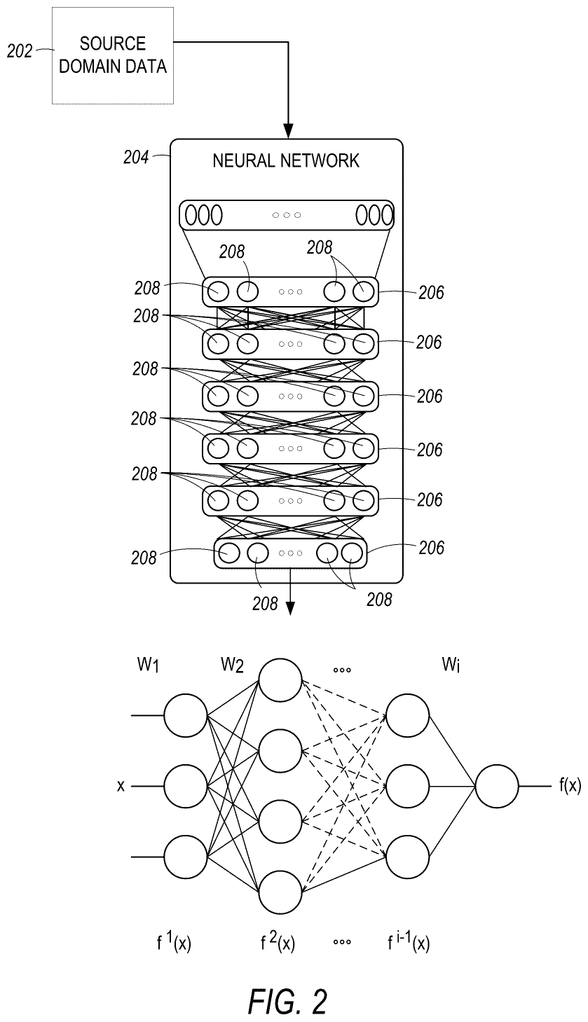

FIG. 2 illustrates an example neural network 204, in accordance with aspects of the present disclosure. As shown, the neural network 204 receives, as input, source domain data 202. The input is passed through layers 206 to arrive at an output. Each layer 206 includes multiple neurons 208. The neurons 208 receive input from neurons of a previous layer and apply weights to the values received from those neurons to generate a neuron output. The neuron outputs from the final layer 206 are combined to generate the output of the neural network 204.

As illustrated at the bottom of FIG. 2, the input is a vector x. The input is passed through multiple layers 206, where weights W1, W2, . . . , Wi are applied to the input to each layer to arrive at f1(x), f2(x), . . . , fi-1(x), until finally the output f(x) is computed.

In examples, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

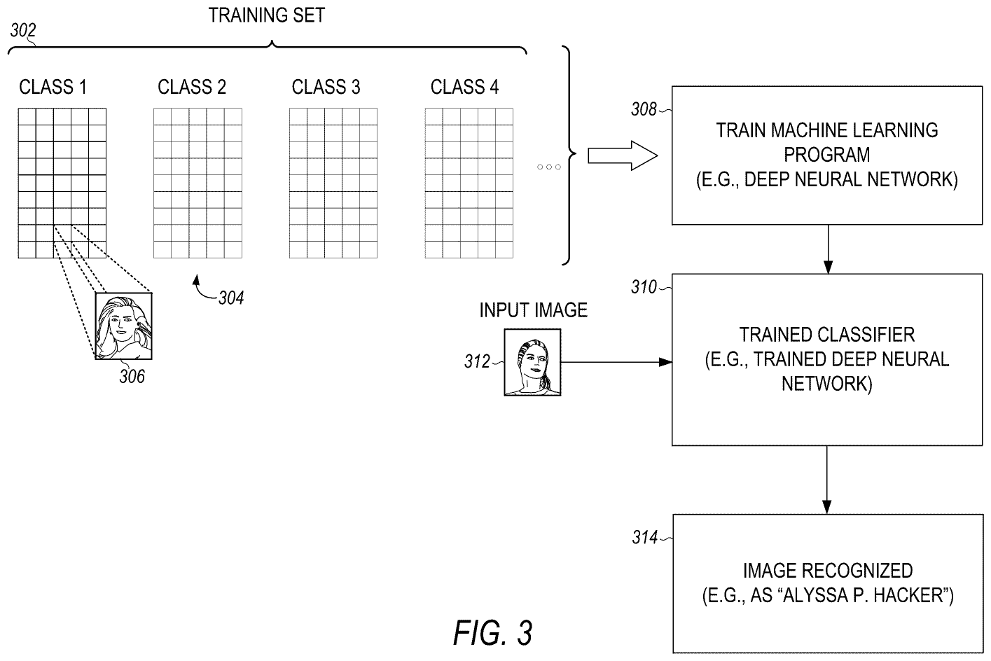

FIG. 3 illustrates the training of an image recognition machine learning program, in accordance with aspects of the present disclosure. The machine learning program may be implemented at one or more computing machines. A training set 302 may include multiple classes 304. Each class 304 includes multiple images 306 associated with the class. Each class 304 may correspond to a type of object in the image 306 (e.g., a digit 0-9, a man or a woman, a cat or a dog, etc.). In some examples, the machine learning program is trained to recognize images of various persons (e.g., to map a photograph of a person to the person's name), and each class 304 corresponds to each person, with each individual class 304 corresponding to an individual person (e.g., one class corresponds to Alyssa P. Hacker). At block 308, the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by a circle with circular arrows.

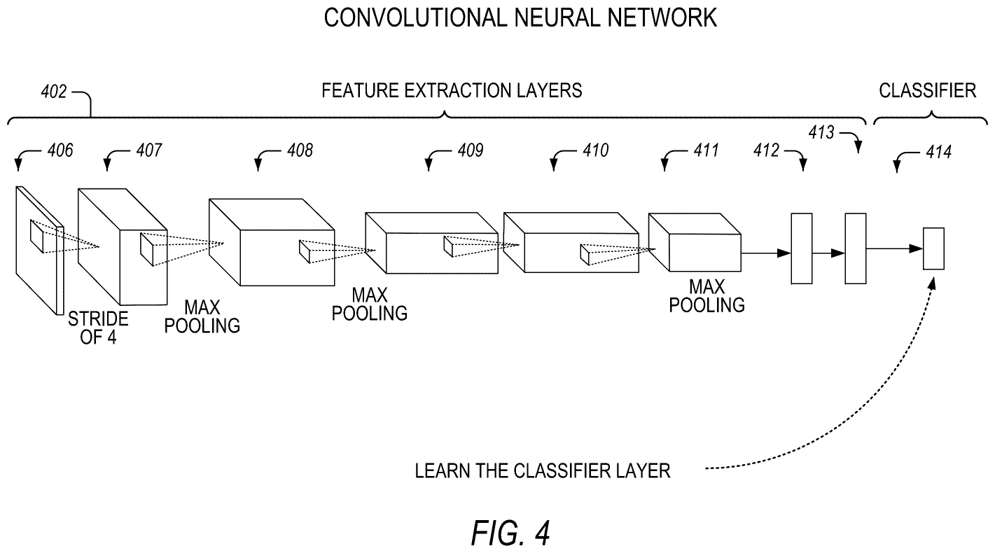

FIG. 4 illustrates a convolutional neural network, in accordance with aspects of the present disclosure. Training a classifier of the convolutional neural network may be accomplished with feature extraction layers 402 and classifier layer 414. Each image is analyzed in sequence by layers 406-413 in the feature extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce an amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In examples, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using the reduced representation instead of the complete initial data. DNN utilizes a stack of layers, where each layer performs a function. For example, the layer could be a convolution, a non-linear transform, the calculation of an average, etc. Eventually the DNN produces outputs by classifier layer 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407, 408, 409, 410, 411, 412, and 413. The stride controls how the filter convolves around the input volume. “Stride of 4” refers to the filter convolving around the input volume four units at a time. Max pooling refers to down-sampling by selecting the maximum value in each max pooled region.

In examples, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

The performance of DNNs may be improved by identifying newer structures for the feature-extraction layers or by improving the way the parameters are identified at the different layers for accomplishing a desired task. One challenge is that for a typical neural network, there may be millions of parameters to be optimized. Trying to optimize all these parameters from scratch may take hours, days, or even weeks, depending on the amount of computing resources available and the amount of data in the training set.

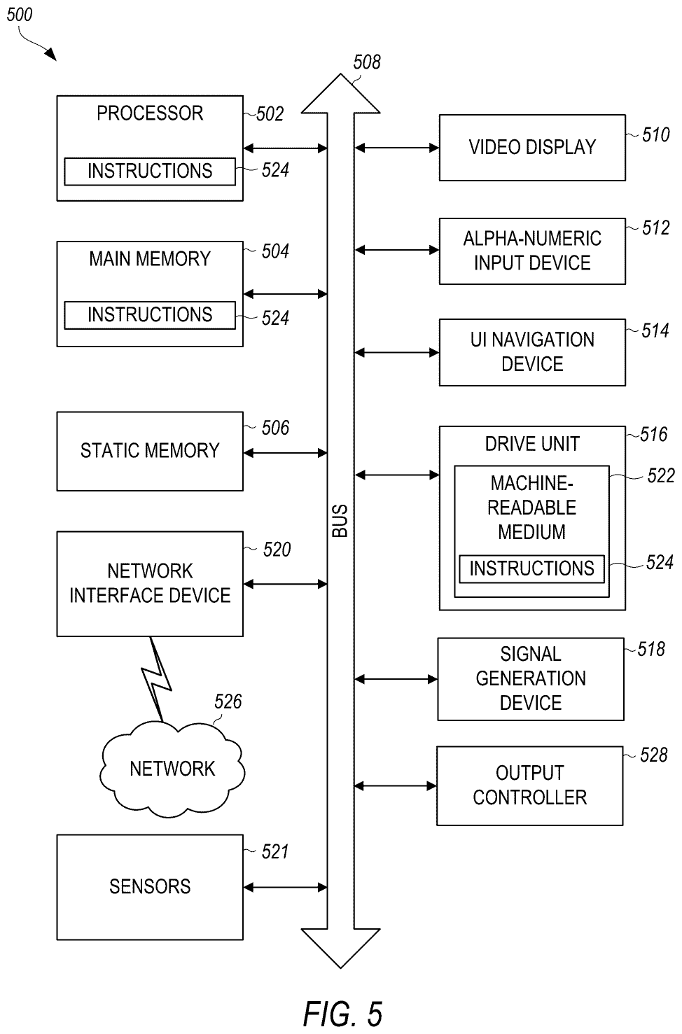

FIG. 5 illustrates a circuit block diagram of a computing machine 500 in accordance with aspects of the present disclosure. In some examples, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative examples, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. As used herein, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink such as a bus 508. Although not shown, the main memory 504 may contain any or all of removable storage and non-removable storage, volatile memory or non-volatile memory. The computing machine 500 may further include a video display unit 510 (or other display unit), an alpha-numeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device such as a drive unit 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 may include a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the drive unit 516 may constitute machine readable media.

While the machine-readable medium 522 is illustrated as a single medium, the term “machine readable medium” may include a single medium or multiple media (e.g., a centralized or distributed database, and/or associated caches and servers) configured to store the one or more instructions 524.

The term “machine-readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine readable media. In some examples, machine-readable media may include machine-readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Memory resources can be limited in edge computing as compared to distributed computing and/or other server-based computing, particularly in the context of edge ML. Edge ML refers to the practice of running machine learning models on edge devices, which are typically closer to the source of data generation compared to cloud-based computing. Edge AI is the process of running AI algorithms on edge devices, which may include devices at the edge of the Internet or other networks. The traditional approach to AI and ML is to use powerful, cloud-based servers to perform model training as well as inference (prediction serving). While edge devices might have limited resources compared to their cloud-based cousins, they offer reduced bandwidth usage, lower latency, and additional data privacy.

An edge device may include a thin device with limited (e.g., compared to a server or a desktop computer) processing hardware, memory hardware, battery power, and/or network interface capabilities. For example, the edge device may have less than a threshold amount of processing hardware, memory hardware, battery power, and/or network interface capabilities. The edge device may be limited by a processing threshold, a memory threshold, a battery power threshold, and/or a network interface threshold. The processing threshold may include the processing hardware being a processing unit (e.g., a central processing unit (CPU)) with less than 1 gigahertz (GHz) clock speed or a limited number of cores (e.g., less than 4 cores). The memory threshold may include the memory hardware may having less 1 gigabyte (GB) of random-access memory (RAM) and/or less than 8 GB of storage. The battery power threshold may be the battery life being less than 4 hours under continuous operation. The network interface threshold may be the edge device having a maximum data transfer rate of less than 100 megabits per second (Mbps) or limited to 2.4 GHz Wi-Fi® connectivity. An edge device may be a single device or may include multiple devices. For example, an edge device may be a thin computer used to capture sensor data in the field in an agricultural, military, or similar setting. Alternatively, the edge device may be an Internet of Things (IoT) device installed in an appliance.

Edge computing is a computer networking strategy where data is processed and stored at the periphery of the network. The “periphery” includes end-user devices and equipment that connects those devices to larger networking infrastructure, such as the internet. For example, laptops, smartphones, routers, and local switches may be referred to as edge computing devices. Alternatively, an edge device may be a “thin” computing device coupled with a sensor, for example, in an IoT device or in a remote location (e.g., a field in an agricultural context or a remote location being studied for military or research purposes) that has limited processing, memory, and/or network access capabilities as described above. By processing data closer to where the data is generated, some advantages may be achieved such as, for example, reduced latency, limited bandwidth usage, improved reliability, and increased data privacy. Most networking architectures can be divided into the “cloud” and the “edge.” Cloud computing consists of applications and services running on remote, internet-connected devices. Edge computing is essentially everything that is not part of the cloud (e.g., in the internet). Local infrastructure information technology (IT) equipment, such as servers and databases, may be considered to be edge devices in some cases, as well.

In general, data will be created by end-point devices. “End-point devices” or “end devices” refer to physical equipment at the very edge of the network, such as laptops, smartphones, and connected sensors. Sometimes, these end devices have a user interface where a person can interact with various applications, enter data, etc. Other times, the device is embedded into other equipment or offers no user interface. These embedded devices, if connected to the internet or other networks, are referred to as the Internet of Things (IoT). Examples of IoT devices include smart speakers, smart thermostats, doorbell cameras, GPS trackers, and networked pressure sensors in factories used to provide flow metrics and detect anomalies. Sometimes, data can be stored and processed on the end device, like saving a local spreadsheet or playing a single-player game.

Edge computing offers a number of benefits. One benefit of edge computing is reduced bandwidth usage. By computing on the edge, there is generally not a need to constantly stream raw data to have it stored, analyzed, or processed by a cloud computing service. Instead, the results of such processing can simply be transmitted. Another benefit of edge computing is reduced network latency. Network latency is the round-trip time it takes for information to travel to its destination (e.g. a cloud server) and for the response to return to the end-point device. For cloud computing, latency can be 100s of milliseconds or more. If processing is performed locally, such latency is often reduced to almost nothing. Other benefits of edge computing include improved energy efficiency (e.g., because transmitting data, especially via a wireless connection like WiFi, usually requires more electrical power than processing the data locally), increased reliability (e.g., because edge computing often allows for data processing to be done without an internet connection), and better data privacy (e.g., because if raw data is processed directly on an end device without travelling across the network, it becomes harder to access by malicious parties, resulting in user data being more secure), among other examples.

In edge AI, neural networks operate under constraints of lower computational power and energy efficiency. Neural networks, in the context of Edge AI, may be designed and optimized to function efficiently in resource-constrained environments, balancing the trade-off between accuracy and performance. Neural network architectures can include multiple layers, each with specific roles and functions. These layers act as the building blocks of the network. The configuration and interaction of these layers define the capabilities of different neural network architectures, allowing them to learn from data and perform a wide array of tasks. From the initial data reception in the input layer through various transformation stages in hidden layers, and finally to the output layer where results are produced, each layer contributes to the network's overall intelligence and performance.

An input layer serves as the initial phase of the neural network. It is responsible for receiving all the input data for the model. The input layer does not perform any computation or transformation. It simply passes the features to the subsequent layers. The dimensionality of the input layer must match the shape of the data. For instance, in image processing tasks, the input layer's shape would correspond to the dimensions of the image, including the width, height, and color channels. A dense layer, often referred to as a fully connected layer, is the most basic form of a layer in neural networks. Each neuron in a dense layer receives input from all the neurons of the previous layer, hence the term “fully connected.” The fully connected layer is a common layer that can be used to process data that has been flattened or transformed from a higher to a lower dimension.

A reshape layer may be used to change the shape of the input data without altering its contents. Reshaping can be particularly useful when the neural network is to prepare the dataset for certain types of layers that require the input data to be in a particular shape. Flatten layers may be used to convert multi-dimensional data into a one-dimensional array. Reshaping may be done before feeding the data into a dense layer. A dropout layer may perform a regularization technique that reduces the risk of overfitting in neural networks. The dropout layer may perform the regularization technique by randomly setting a fraction of the input units to zero during each update of the training phase, which helps to make the network more robust and less sensitive to the specific weights of neurons.

A one-dimensional (1D) convolution layer may be specifically designed for analyzing sequential data, such as audio signals or time-series data. A 1D convolution type of layer applies a series of filters to the input data to extract features. These filters slide over the data to produce a feature map, capturing patterns like trends or cycles that span over a sequence of data points. Complementing the 1D convolution layer, a 1D pooling layer may be configured to reduce the spatial size of the feature maps, thus reducing the number of parameters and computation in the network. It works by aggregating the information within a certain window, usually by taking the maximum (Max Pooling) or the average (Average Pooling) of the values. Such an operation also helps to make the detection of features more invariant to scale and orientation changes in the input data.

Two-dimensional (2D) convolution layers may be used primarily for image data and other two-dimensional input (like spectrograms). These layers operate with filters that move across the input image's height and width to detect patterns like edges, corners, or textures. Each filter produces a 2D activation map that represents the locations and strength of detected features in the input. A 2D pooling layer may serve a similar purpose as its 1D counterpart but in two dimensions. After the convolution layer has extracted features from the input, the pooling layer reduces the spatial dimensions of these feature maps. The pooling layer summarizes the presence of features in patches of the feature map and reduces sensitivity to the exact location of features. Maximum (“max”) pooling and average pooling are common types of pooling operations used in 2D pooling layers.

An output layer is the final layer in a neural network architecture, responsible for producing the results based on the learned features and representations from the previous layers. Its design is closely aligned with the specific objective of the neural network, such as classification, regression, or even more complex tasks like image segmentation or language translation.

An activation function is a mathematical equation that determines the output of a neural network node, or “neuron.” The activation function adds non-linearity to the neural network, allowing the neural network to learn complex patterns in the data. Without activation functions, a neural network would simply be a linear regression model, incapable of handling complex tasks like image recognition or language processing. Several activation functions are used in neural networks, each with its characteristics and typical use cases. Some of the most common include the rectified linear unit (ReLU). A ReLU allows only positive values to pass through, introducing non-linearity. ReLU is efficient and widely used in deep learning. It may be used by default for hidden layers. A sigmoid is a function that maps values into a range between 0 and 1, making it ideal for binary classification problems. A hyperbolic tangent (Tanh) is similar to the sigmoid but maps to values between −1 and 1. It is useful in hidden layers of a neural network. A softmax function may be used in the output layer of a neural network for multi-class classification. The softmax function is a function that converts a vector of K real numbers into a probability distribution of K possible outcomes. The softmax function may be used to turn logits into probabilities that sum to one. A leaky ReLU is a variation of ReLU that allows a small, non-zero gradient when the unit is not active. The choice of activation function depends on the specific task and the characteristics of the input and output data. For instance, ReLU and its variants are generally preferred in hidden layers due to their computational efficiency. Sigmoid or softmax functions are often used in the output layer for binary and multi-class classification tasks, respectively.

A loss function, also known as a cost function, is a method to measure the performance of a machine learning model. Essentially, it calculates the difference between the model's predictions and the actual target values. The goal of training a neural network is to minimize the difference, thereby improving the model's accuracy. The loss function quantifies how well the model is performing. A higher loss indicates greater deviation from the actual values, while a lower loss signifies that the model's predictions are closer to the target values. The loss function is a mathematical expression that measures the difference or ‘error’ between the actual output (prediction) of a model and the desired output (label). It helps evaluate how well the model is performing. In other words, it quantifies the cost of misclassification. In contrast, an optimizer is an algorithmic entity designed to minimize the loss function. A goal of the optimizer is to adjust the parameters (weights and biases) of a neural network in such a way that the loss is minimized. The parameters can be adjusted through iterative processes like gradient descent or its variations. The optimizer calculates the partial derivative of the loss with respect to each parameter, which indicates the direction and magnitude of changes needed to reduce the loss. So, while the loss function quantifies how ‘wrong’ the model is, the optimizer tries to minimize the error by changing the parameters of the model.

Compiling ML models for execution on an edge device may be challenging due to large memory requirements of the ML model. Systems and techniques provide an edge AI compiler configured to compile ML models for execution on edge devices. The edge AI compiler may include a memory planner configured to determine a memory allocation scheme for execution of the ML model on the edge device and a compiling component configured to compile the ML model based on the memory allocation scheme. A memory allocation scheme may include operations to assign certain data (e.g., data structures, variables, and so forth) to certain memories, prioritize certain data over other data, and/or deallocate data as required. The edge AI compiler may compile machine learning models into highly efficient and hardware-optimized C++ source code. In some implementations, the edge AI compiler may support a wide variety of neural networks trained in TensorFlow or PyTorch—and a large selection of classical ML models trained in scikit-learn, LightGBM or XGBoost.

In some implementations, edge device information may be received. The edge device information may indicate a target device or devices. For example, a first target device may be indicated for implementation of a first ML model and a second target device may be indicated for implementation of a second ML model. In some implementations, a first target device and a second target device may be indicated for implementation of a single ML model. Any number of different target devices may be indicated for implementation of any number of different components of any number of ML models.

A deployment service may automatically determine performances of multiple configurations of a pipeline (sometimes referred to as machine learning pipeline or an impulse), based on the target devices indicated by the edge device information, for implementing a configuration of the multiple configurations on the target device. The pipeline may include one or more machine learning components (e.g., one or more components implementing conditional logic, a neural network, a heuristic algorithm, or other learning algorithm or classifier). The one or more machine learning components may be connected to one another in various ways.

A configuration of the pipeline may include one or more parameters for configuring the machine learning component (e.g., settings that affect machine learning, such as hyperparameters including neural network topology, size, or training). Configurations of the multiple configurations may vary in the one or more parameters that are used, and therefore may vary in configurations of the one or more signal processing components and/or the one or more machine learning components. The performance of a configuration may be determined based on the target device, and the target device may be indicated by the input. For example, the target device may be indicated by a user via selection of the target device from a library of multiple possible target devices. The target device could be, for example, a device (e.g., a microcontroller or board), a computer, or a mobile phone. In some implementations, the target device could comprise a system running in a cloud server. The performance of a configuration may also be determined based on an application constraint (e.g., a targeted latency, accuracy, memory usage, and/or energy usage), and the application constraint may be indicated by an input. For example, the application constraint may be indicated by a user for meeting the needs of a given application (e.g., achieving a shorter inference time for predicting the movement of a UAV).

In some implementations, the performance of a configuration may be determined by calculating a latency (e.g., an inference time), a memory usage (e.g., a random access memory (RAM) and/or a read only memory (ROM) usage), an energy usage (e.g., power consumption), and/or level of accuracy associated with the configuration when implemented on the target device. For example, the latency, or inference time, may be an amount of time for the configuration of the pipeline to process input data and produce output data when the configuration is implemented on a target device; the memory usage may be a peak amount of RAM and/or a peak amount of ROM, measured in kilobytes or megabytes, consumed by the target device when implementing the configuration; the energy usage may be a peak amount of power, measured in watts, consumed by the target device when implementing the configuration; and the accuracy may be a fraction or percentage of predictions that the target device correctly determines when implementing the configuration. In some implementations, the performance (e.g., the latency, memory usage, energy usage, or accuracy) of a configuration may be determined by simulating the target device implementing the configuration (e.g., determining the performance based on characteristics of the target device, such as the architecture of a device). In some implementations, the performance of a configuration may be determined by referencing one or more benchmarks associated with the target device (e.g., predetermined performance data from a look up table or other data structure) and applying the one or more benchmarks to estimate the performance of the configuration when the target device implements the configuration. In some cases, a machine learning model or heuristic algorithm may be used to predict the performance of the configuration based on the one or more benchmarks. Such a solution may permit determining the performance more quickly when using benchmarks. In some implementations, the configurations may be ranked based on their performances. In some implementations, the performance of a configuration may be compared to an application constraint (e.g., a targeted latency, accuracy, memory usage, and/or energy usage) indicated by an input. In some implementations, a configuration may be selected, based on the configuration satisfying the application constraint, for implementing the configuration on the target device (e.g., a microcontroller or board implementing a given architecture). In some implementations, the configuration may be implemented on a target device by utilizing a software toolchain for the target device, such as for generating firmware. In some implementations, implementing the configuration on a target device may include determining portions of the pipeline to be implemented on various cores of a heterogenous device, and distributing a computational workload associated with the pipeline across the various cores. In some implementations, a graphical user interface (GUI) may be used when configuring the pipeline.

As a result, a pipeline including one or more machine learning components may be determined for an application and/or a device while reducing the time and/or the burden (e.g., measured in at least one of processor use, memory use, and/or energy use) associated with making the determination. Further, the pipeline may be implemented on a target device while reducing the time and/or the burden associated with utilizing the software toolchain for the target device. Additionally, by determining configurations that include machine learning components, trade-offs between latency and RAM usage may be achieved.

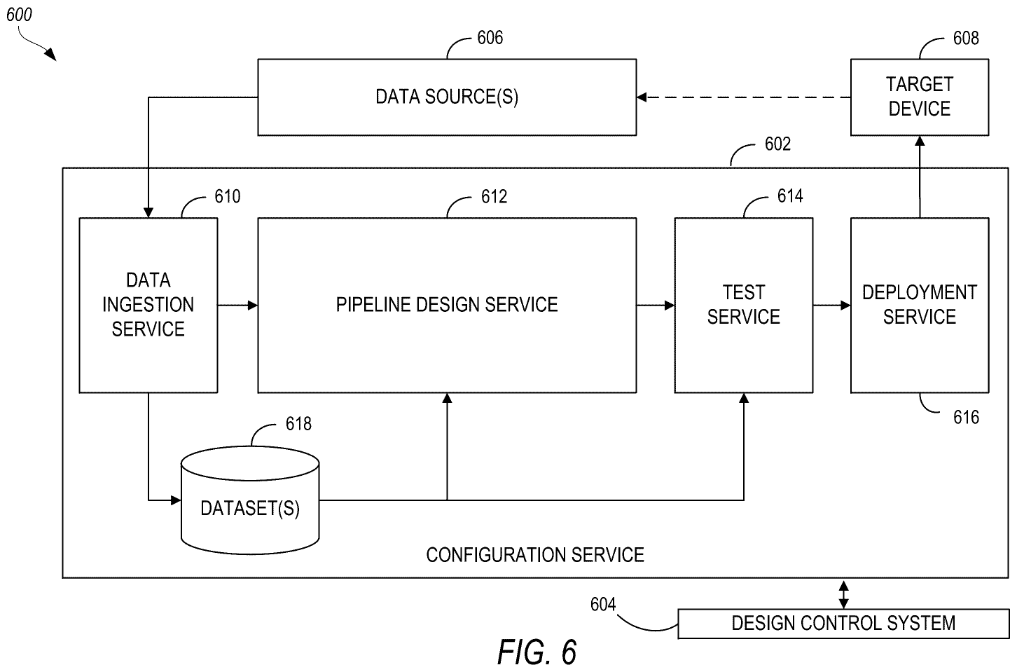

FIG. 6 is a block diagram of an example of a system 600 for configuring a machine learning pipeline, in accordance with aspects of the present disclosure. The system 600 may include a configuration service 602, a design control system 604, one or more data sources 606, and a target device 608.

The configuration service 602 may be a software platform instantiated using one or more servers at one or more datacenters. The configuration service 602 may include a data ingestion service 610, a pipeline design service 612, a test service 614, and a deployment service 616. The data ingestion service 610 may receive input data from the one or more data sources 606. The input data may be used by the configuration service 602 to generate one or more datasets that may be used to configure, train, and/or test a configuration of the pipeline. The one or more datasets may be stored by the configuration service 602 in a database 618. The one or more data sources 606 could be selected and/or configured by the user via the design control system 604. The one or more data sources 606 could also be configured by the configuration service 602, such as for transferring the input data from the one or more data sources 606 to the configuration service 602. The one or more data sources 606 may include, for example, one or more servers, computers, mobile phones, or other electronic devices, such as microcontrollers or boards.

The pipeline design service 612 may be used to configure one or more configurations of a pipeline (e.g., a machine learning pipeline) to be implemented on the target device 608 (e.g., a specified microcontroller, board, computer, or mobile phone). The pipeline design service 612 may be used to configure one or more machine learning components (e.g., one or more components implementing conditional logic, a neural network, a heuristic algorithm, or other learning algorithm, such as a classifier) for the pipeline.

Various parameters may be used to configure a configuration of the pipeline. The pipeline design service 612 may determine the parameters for configuring the one or more machine learning components. Examples of parameters for configuring a machine learning component may include selection of a learning process (e.g., conditional logic, neural network, heuristic algorithm, or other learning algorithm, such as a classifier), and hyperparameters, such as number of training cycles, learning rate, validation set size, neural network topology, neural network size, types of layers, and order of layers. For example, parameters for a neural network may configure layers as dense, 1D convolution, or 2D convolution, and/or to reshape, flatten, and/or dropout. In some implementations, the pipeline design service 612 may determine the parameters based on user input of parameters, the target device 608, an application constraint (e.g., a targeted latency, accuracy, memory usage, and/or energy usage), and/or datasets stored in the database 618. One or more of the user input of parameters, the target device 608, the application constraint, and/or the datasets may be indicated by input from a user, such as via the design control system 604. One or more parameters may be specified and/or modified by a user, such as via the design control system 604.

In some cases, for example, the one or more datasets may include edge device information. Edge device information may be indicative of one or more capabilities of the target device 608. Capabilities of the target device 608 may include parameters such as memory usage (e.g., RAM and/or ROM availability by the target device 608) and/or energy usage (e.g., power limitations of the target device 608), and constraints associated with application of the target device 608, such as latency (e.g., inference time) and/or level of accuracy (e.g., predictions). Further, target devices may differ from one another with respect to implementing the pipeline (e.g., the software toolchains involved to implement a configuration of the pipeline on a target device may differ), with more complex target devices sometimes involving a more complex implementation. Further, target devices may differ from one another with respect to performance (e.g., some target devices may inherently perform better than others, such as devices having more execution units and higher clock frequencies performing better than devices having fewer execution units and lower clock frequencies).

The test service 614 may be used to test the one or more configurations of the pipeline. In some implementations, the test service 614 may use data from datasets stored in a database 618 to test the or more configurations of the pipeline to generate feedback. For example, the test service 614 may test the one or more configurations with respect to latency (e.g., inference time), level of accuracy of predictions, memory usage (e.g., RAM and/or ROM), and/or energy usage (e.g., power consumption). The test service 614 may provide such feedback to a user, via the design control system 604, so that the user may accept or change a configuration of the pipeline based on the testing. In some implementations, the test service 614 may use the feedback to identify one or more parts of the configuration of the pipeline (e.g., a signal processing component or a machine learning component) to change.

The deployment service 616 may be used to deploy a configuration of the pipeline to the target device 608. The target device 608 may be indicated by a user via the design control system 604. In some implementations, the target device 608 may be indicated by a selection of the target device 608 from a library of multiple possible target devices. The target device 608 could be, for example, a device (e.g., a microcontroller or board), a computer, or a mobile phone. In some implementations, the target device 608 could comprise a system running in a cloud server. The deployment service 616 may utilize a software toolchain, specific to the target device 608, for generating software and/or firmware for deploying the configuration of the pipeline to the target device 608. For example, a software toolchain may include a set of programming tools (e.g., a compiler, linker, libraries, and debugger) provided by a manufacturer or vendor for programming a particular device, library, computer, or mobile phone.

In some implementations, the deployment service 616 may communicate with a programming system to send the software and/or firmware to the programming system for programming the target device 608. For example, the deployment service 616 may generate a binary that may be used to flash, or program the ROM, of a device corresponding to the target device 608. Thus, the target device 608, when programmed, may implement a configuration of the pipeline that may be used for machine learning on a target having constraints. For example, the target device 608 could be an embedded device that implements embedded machine learning.

Implementations of the present disclosure permit automatically determining the performances of multiple configurations of a pipeline for implementation on the target device 608. The configuration service 602 may receive input, such as selection of the target device 608, selection of application constraints (e.g., a targeted latency, accuracy, memory usage, and/or energy usage), selection of one or more data sources 606, selection of input data, and/or selection of one or more parameters. The input may be provided by a user via the design control system 604. The configuration service 602 may execute to generate multiple configurations of a pipeline based on the input (e.g., selection of the target device 608, the application constraints, the input data, and/or the one or more parameters). The multiple configurations may vary in the parameters that are used, including parameters that may be specified by the user, and therefore may vary in configurations of the one or more machine learning components. Thus, the performance of a first configuration of the pipeline that may be implemented on the target device 608 may vary from the performance of a second configuration of the pipeline of the pipeline that may be implemented on the target device 608. The configuration service 602 may execute to determine the performances of the multiple configurations of the pipeline that it determines based on the input (e.g., selection of the target device 608, the application constraints, the input data, and/or the one or more parameters). The performances of the multiple configurations may be determined, for example, by calculating latencies (e.g., inference times), memory usage (e.g., RAM and/or ROM usage), energy usage (e.g., power consumption), and/or levels of accuracy associated with the configurations when implemented on the target device 608.

In some implementations, the performance of a configuration may be determined by simulating the target device 608 implementing the configuration. Simulating the target device 608 implementing the configuration may permit determining the performance based on characteristics of the target device 608, such as the particular architecture implemented by the target device 608. For example, simulating the target device 608 may include executing compiled code (e.g., computer instructions) implementing the pipeline on a virtual version of the target device 608. In some implementations, the performance of a configuration may be determined by referencing one or more benchmarks associated with the target device 608 (e.g., predetermined performance data from a look up table or other data structure) and applying the one or more benchmarks to estimate the performance of the configuration when the target device 608 implements the configuration. In some cases, a machine learning model or heuristic algorithm may be used to predict the performance of the configuration based on the one or more benchmarks. Predicting the performance of the configuration based on the one or more benchmarks may permit determining the performance more quickly when using benchmarks. In some implementations, the configurations may be ranked based on their performances with their relative rankings displayed to a GUI. In some implementations, the performance of a configuration may be compared to an application constraint (e.g., a targeted latency, accuracy, memory usage, and/or energy usage) indicated by an input and displayed to a GUI. In some implementations, a configuration may be selected, based on the configuration satisfying the application constraint, for implementing the configuration on the target device 608 (e.g., a microcontroller or board implementing a given architecture). In some implementations, the configuration may be implemented on the target device 608 by utilizing a software toolchain for the target device 608, such as for generating software and/or firmware that is specific to the target device 608. In some implementations, implementing the configuration on the target device 608 may include determining portions of the pipeline to be implemented on various cores of a heterogenous device (e.g., a device including multiple types of processors and instruction sets), and may include distributing a computational workload associated with the pipeline across the various cores. In some implementations, a GUI may be used when configuring the pipeline, such as a GUI displayed to a user via the design control system 604.

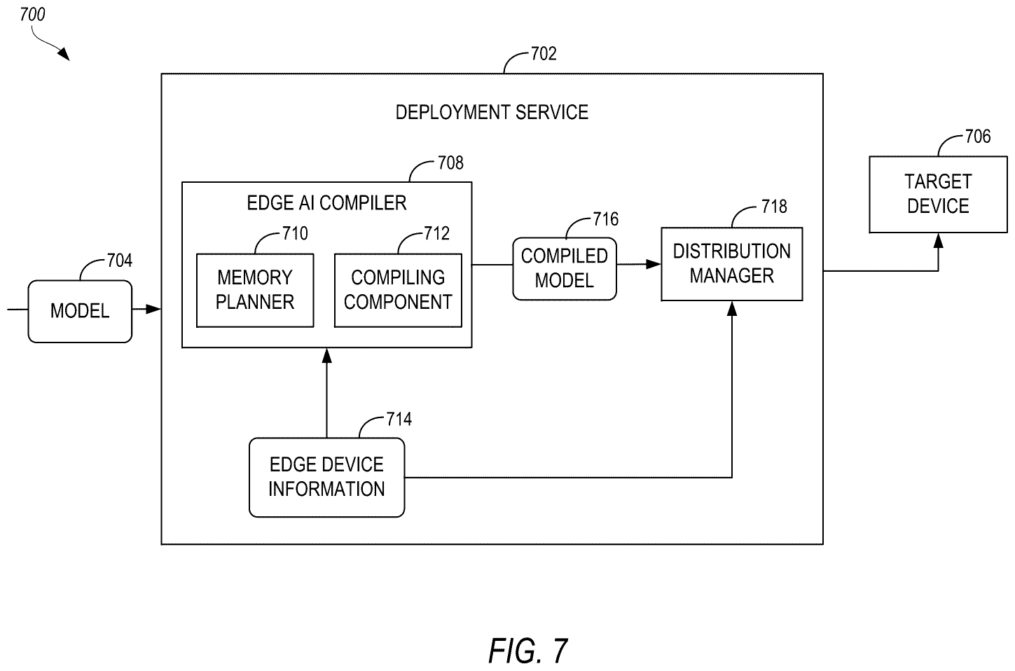

FIG. 7 is a block diagram illustrating an example of a system 700 including a deployment service 702 of a machine learning pipeline, in accordance with aspects of the present disclosure. System 700 includes deployment service 702, which is configured to receive a model 704 and deploy it to a target device 706. The target device 706 may be an edge device. The deployment service 702 comprises an edge AI compiler 708, which includes a memory planner 710 and a compiling component 712.

The edge AI compiler 708 processes the model 704 with consideration of edge device information 714 to compile the model. The memory planner 710 utilizes the edge device information 714 to develop a memory allocation scheme. The compiling component 712 compiles the model 704 according to the memory allocation scheme, producing a compiled model 716.

The compiled model 716 is then managed by a distribution manager 718, which is responsible for deploying the compiled model to the target device 706. The figure illustrates an interaction where the distribution manager 718 receives input from both the compiled model 716 and the edge device information 714, ensuring that the deployment is optimized for the specific target device 706.

In some implementations, the edge AI compiler 708 may determine a memory allocation scheme tailored to the specific constraints and capabilities of the target device 706. Such a process may facilitate ensuring that the compiled model runs efficiently and effectively within the limited resources available on the target device 706. In some implementations, the edge AI compiler 708 may determine the memory allocation scheme based on capabilities of one or more classes of edge devices.

The determination of the memory allocation scheme may begin with the memory planner 710 obtaining a compute graph associated with the machine learning model 704. The compute graph represents the various computational nodes and operations required to perform inference using the model. The analysis lays the foundation for understanding the memory demands of each component within the model's computational structure.

Once the compute graph is obtained, the memory planner 710 determines a set of activation blocks that correspond to each compute node within the compute graph. Each activation block is associated with a specific memory usage value, representing the amount of memory required to store the intermediate results and weights during the execution of that node. By analyzing these memory usage values, the memory planner 710 identifies the maximum memory usage value, thus identifying the activation block that demands the most memory.

To optimize memory usage, the memory planner 710 may generate a modified activation block by adjusting the original activation block associated with the maximum memory usage. The modification aims to reduce the memory footprint of the most demanding block, thereby lowering the overall memory requirements of the model 704. The modified activation block is designed to consume less memory without significantly impacting the performance or accuracy of the model. In some implementations, the activation block may be modified by dividing a computation into two or more computations, releasing cached memory associated with a computation of the activation block once the output has been provided as input to a next computation and/or activation block, aggregating multiple computations into one computation, and/or replacing a computation with a similar computation that has a lower memory impact, among other examples.

The memory planner 710 may incorporate edge device information 714 into the memory allocation scheme determination process. The edge device information may include parameters such as available RAM and ROM, as well as other memory constraints specific to the target device 706. By integrating these parameters, the memory planner 710 ensures that the memory allocation scheme aligns with the hardware limitations and capabilities of the target device 706, facilitating execution of the compiled model. In some implementations, for each compute graph, the memory planner 710 may calculate the maximum memory necessary to store all activation tensors at any time. The memory planner 710 may allocate the determined maximum amount of memory. In an example, the machine learning model is compiled for the target processor. Then, the memory planner 710 determines a size of the static memory from the resulting map file and augments the size with a size of the associated arena (or region). In some cases, all operations of the machine learning model may request a memory allocation only during an initial phase such that after initialization, the memory planner 710 has accurately determined the arena (region) size. Then, while executing the compute graph, the memory planner 710 may dynamically allocate activation tensors (e.g., re-using previously allocated memory).

In analyzing a compute graph, the memory planner 710 may evaluate potential functions within the graph that can be subdivided into smaller computational blocks to alleviate the memory burden on an edge device. The memory planner 710 may identify portions of the compute graph where single computations can be broken down and executed in segments, thus reducing peak memory usage during the processing of the machine learning model.

The edge AI compiler 708 may be configured to generate a modified compute graph by optimizing memory usage in accordance with any number of different memory optimization paradigms, which may be implemented as modes of operation. For example, the edge AI compiler 708 may operate in a latency optimization mode and/or a RAM usage optimization mode, among other examples. The operational modes may enable the compiler to adapt the memory planning process according to specific operational requirements of the target edge device.

In the latency optimization mode, the memory allocation can be optimized based on a set of rules designed to reduce inference time. A goal is to ensure that the execution of machine learning models on edge devices is as fast as possible, given their limited processing capabilities. To achieve such a goal, the compiler may prioritize the allocation of memory to important compute nodes that are bottlenecks in the computational graph. It may employ strategies such as preloading data into memory before it is needed, minimizing data transfer times, and utilizing faster memory regions where available. Additionally, overlapping memory allocation for non-concurrent operations can be reduced to ensure quick data access and processing, thereby enhancing the overall speed of inference.

Conversely, in the RAM optimization mode, the memory allocation can be optimized according to a set of rules focused on minimizing the peak memory usage. The setting may be used for edge devices that have stringent RAM constraints. The edge AI compiler 708 may break down large activation blocks into smaller segments to fit within the available memory resources. By using techniques such as memory re-use, where the same memory region is allocated for different purposes at different times, and layer-wise memory allocation, where memory is allocated and released immediately after use, the edge AI compiler 708 can significantly reduce the overall memory footprint of the deployed model. The edge AI compiler 708 may also employ techniques to compress intermediate data representations without significantly impacting model accuracy, thus further lowering RAM consumption.

By offering these customizable modes, the edge AI compiler may allow for a more resource-efficient deployment of machine learning models, ensuring that the compiled models can perform optimally within the varying constraints of different edge devices.

The memory planner 710 may generate memory allocation schemes that can be customized based on specific requirements. For instance, a memory allocation scheme indication may instruct the memory planner 710 to prioritize latency optimization or RAM optimization. Depending on the selected optimization model, the memory planner 710 applies a corresponding set of rules to refine the memory allocation scheme further. Latency optimization may involve techniques focused on minimizing inference time, while RAM optimization employs strategies to reduce the overall memory consumption of the model.

The compiling component 712 compiles the ML model 704 based on the determined memory allocation scheme. The process of compiling the ML model 704 may include generating a flattened compute graph, which is a sequential compute graph. In some implementations, a compute graph may include sequential activations, while execution on an edge device may be more practically performed in parallel, from a memory allocation perspective. Thus, the compiling component 712 (and/or the memory planner 710) may reorganize the modified compute graph into a flattened compute graph in which the activations are configured for parallel memory activation. The resulting compiled ML model is thus optimized for the constrained environment of the edge device, balancing the trade-offs between memory usage, latency, and accuracy to deliver optimal performance. The optimization reduces the maximum memory necessary to store all activation tensors at any time, thereby enabling larger models to run on a device with limited memory compared to those without the optimization.

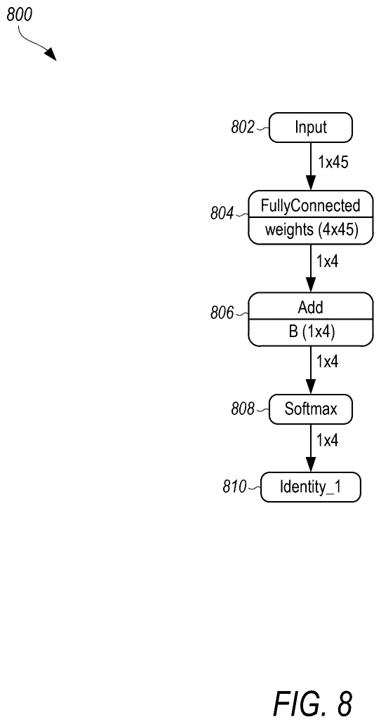

FIG. 8 shows an illustrative compute graph 800 that represents a sequence of operations within a neural network model, in accordance with aspects of the present disclosure. The compute graph 800 includes multiple interconnected nodes, each performing a specific function for processing inputs through the neural network.

The process begins with the input 802, which is a data vector represented as a 1×45 matrix. The input 802 is provided to a fully-connected layer 804. The fully-connected layer 804 consists of weights organized in a 4×45 matrix, transforming the input data vector into an intermediate 1×4 vector. The transformation enables the model to capture and learn complex representations of the input data.

Following the fully-connected layer 804, the intermediate 1×4 vector is processed by addition function 806. The function adds a bias term, represented as a 1×4 matrix, to the vector output produced by the fully connected layer 804. The bias term adjusts the outputs of the preceding layer by incorporating an additional learned parameter, enhancing the model's ability to fit the input data.

The resulting vector from the addition function 806 is then passed to the softmax function 808. The softmax function 808, which also takes a 1×4 vector as input, normalizes the vector into a probability distribution over four possible classes. The function ensures that the output probabilities range between 0 and 1 and sum to 1, making it suitable for classification tasks.

Finally, the normalized probability vector is directed to the output 810, labelled as Identity_1. The output 810 represents the final computed probability distribution resulting from the processing of the initial input 802 through the various layers and functions comprising the compute graph 800. The probability distribution indicates the model's predictions for each class, completing the sequence of operations depicted in FIG. 8.

The edge AI compiler can analyze the compute graph illustrated in FIG. 8 to identify opportunities for memory optimization. In such an example, the compute graph comprises several layers, beginning with an input layer, followed by a fully-connected layer, an addition function, a softmax function, and concluding with the output layer. The key to optimizing memory usage involves understanding the sequence of operations and the dependencies between the various computational nodes within the compute graph.

When the input data vector [1×45 matrix] is fed into the fully-connected layer, it undergoes a transformation into an intermediate 1×4 vector guided by the weights organized in a 4×45 matrix. The edge AI compiler can determine that, once the transformation is complete and the intermediate vector is produced, the original input data has fulfilled its purpose in the computation pipeline. Consequently, the memory allocated for storing the input data vector can be released as it is no longer needed for subsequent operations. The release is advantageous because it releases, or deallocates, memory resources on the edge device, which typically has limited memory capacity. By systematically deallocating memory associated with data that has been fully processed, the edge AI compiler can generate a memory allocation scheme optimized for efficient execution on the edge device, thereby allowing more complex models to run effectively within the constrained environment.

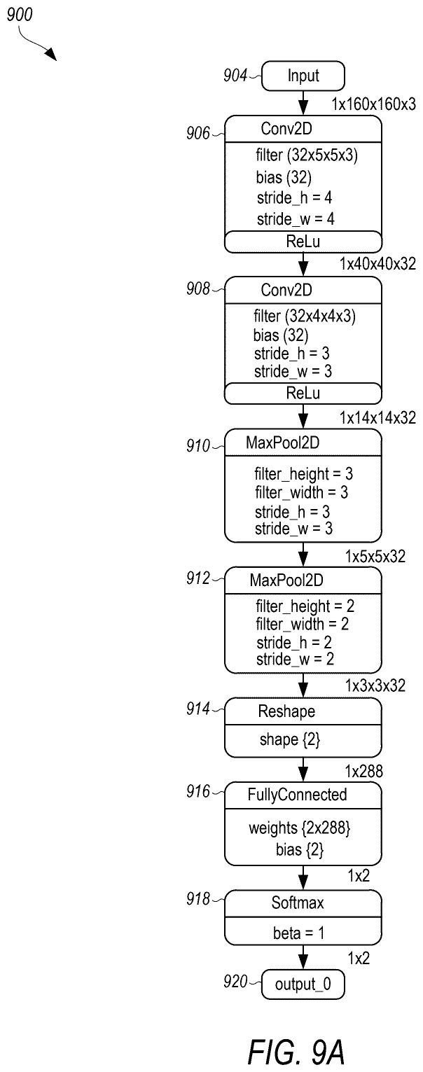

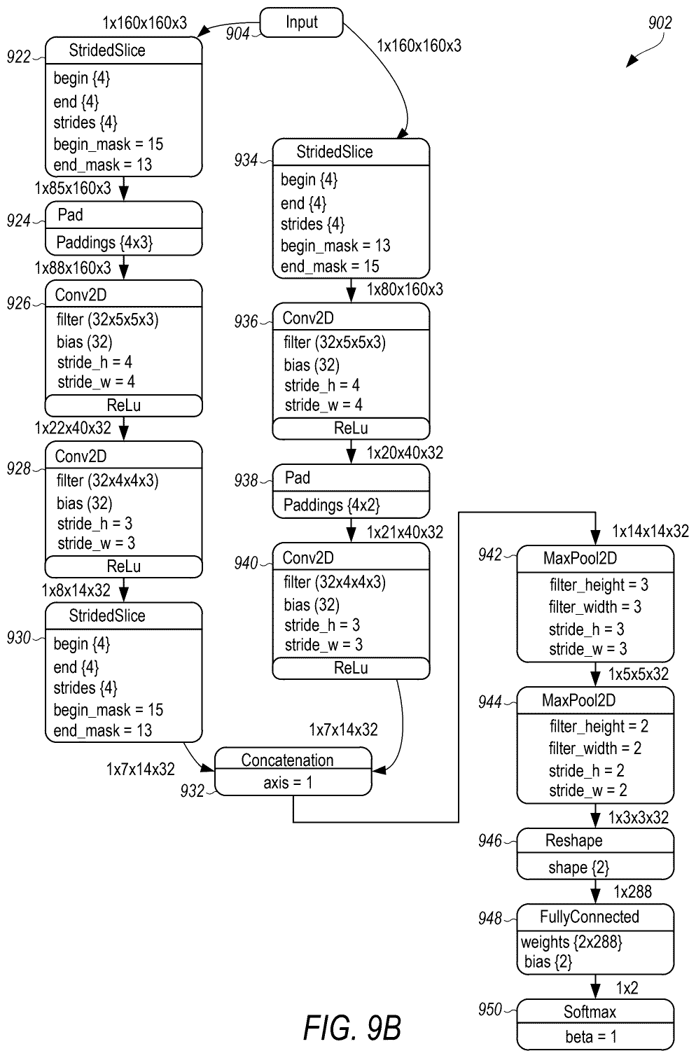

FIG. 9A shows a compute graph 900 associated with a machine learning model, in accordance with aspects of the present disclosure. The machine learning model may be, or be similar to, the model 704 shown in FIG. 7. The compute graph begins with an input tensor 904 of dimensions 1×160×160×3, which is processed by a first 2D convolutional layer 906 with filter dimensions 32×5×5×3 and a bias term of 32, with strides of 4 in both height and width. The activation function employed at the first 2D convolutional layer 906 is ReLu. The output of the layer is a transformed vector of dimensions 1×40×40×32. The transformed vector is processed by a second 2D convolutional layer 908. The second 2D convolutional layer 908 layer uses filters sized 32×4×4×3 with biases of 32, and applies strides of 3 in both height and width, once again employing a ReLu activation function. The resulting output from the layer has dimensions of 1×14×14×32.

Next, a first max pooling layer 910 is applied with a filter of height and width set to 3 and strides of 3 in both directions. The pooling operation reduces the dimensions to 1×5×5×32. A second max pooling layer 912 is applied, which has a filter height and width of 2, with strides of 2 in both dimensions, yielding an output having dimensions of 1×3×3×32. Following the pooling operations, the data undergoes a reshaping operation in reshape layer 914, changing the dimensions from 1×3×3×32 to 1×288. The reshaped data is then fed into a fully-connected layer 916 that contains weights {2×288} and biases {2}, which results in an output, having dimensions of 1×2, that is passed to a softmax function 918, set with beta value of 1. The function generates probabilistic predictions as outputs. The final result is provided as output 920 (shown as “output_0”), producing a 1×2 tensor.

FIG. 9B illustrates a compute graph 902 that is a modified rendition of compute graph 900, in accordance with aspects of the present disclosure. The compute graph 902 may be generated, for example, by a memory planner (e.g., the memory planner 710 shown in FIG. 7) of an edge AI compiler (e.g., the edge AI compiler 708). For example, the memory planner may determine a memory allocation scheme as described above in connection with FIGS. 7 and 8 and may apply the memory allocation scheme to the compute graph 900 to generate the compute graph 902. The memory allocation scheme may be configured to reduce the maximum memory necessary to store all activation tensors at any given time, thereby enabling the ML model associated with the compute graph 900 to be implemented on an edge device having limited memory as compared to a server, for example.

As shown, the compute graph 902 includes parallel operational paths configured to replace the 2D convolutional layers 906 and 908 shown in FIG. 9A. For example, the memory planner may use a stride of 4 filter 922 employing filter strides of 4, and begin and end masks to establish an output tensor of 1×85×160×3. A padding layer 924 (having padding dimensions of {4×3}) may be used to adjust the size of the tensor to 1×88×160×3 for inputting to the first 2D convolutional layer 926. Because the tensor size 1×88×160×3 is the maximum tensor size that needs to be stored for an activation function in the compute graph 902, the maximum memory allocation corresponds to that tensor size, which is significantly lower than the maximum tensor size of 1×160×160×3 stored for an activation function in the compute graph 900. The first 2D convolutional layer 926 includes filters of 32×5×5×3 and biases of 32, applying strides of 4 and using ReLu activation to produce an output tensor sized 1×22×40×32. A second 2D convolutional layer 928 is configured with filters sized 32×4×4×3 and biases of 32, and applies strides of 3 and utilizes the ReLu activation function to generate an output tensor of 1×8×14×32. Subsequently, an additional stride of 4 filter 930 is used to further reduce the tensor dimensions to 1×7×14×32. The resulting 1×7×14×32 tensor is provided to a concatenation layer 932.

In the parallel stream, a stride of 4 filter 934 is used to generate a tensor of 1×80×160×3, which is processed by a third 2D convolution layer 936 configured with filters of 32×5×5×3, applying stride values of 4, and producing an intermediate tensor of 1×20×40×32. The intermediate tensor is subsequently padded using padding layer 938, resulting in an output tensor sized 1×21×40×32. The padded tensor is passed through a fourth 2D convolutional layer 940, akin to the configuration of convolutional layer 928, producing a tensor sized 1×7×14×32. The outputs from both streams are concatenated in the concatenation layer 932 to produce a tensor sized 1×14×14×32, which is processed in a max pooling layer 942 (having a filter size of 3×3 and in which strides=3), which reduces the tensor to dimensions 1×5×5×32. The tensor undergoes further dimensionality reduction via max pooling layer 944 (filter size of 2×2, strides=2), yielding an output tensor of 1×3×3×32. Finally, the tensor undergoes transformation in reshape layer 946, changing the dimensions to 1×288, which is then processed by a fully-connected layer 948 with weights {2×288} and biases {2}, producing an output tensor of 1×2·A softmax function 950 generates the final probabilistic output tensor.

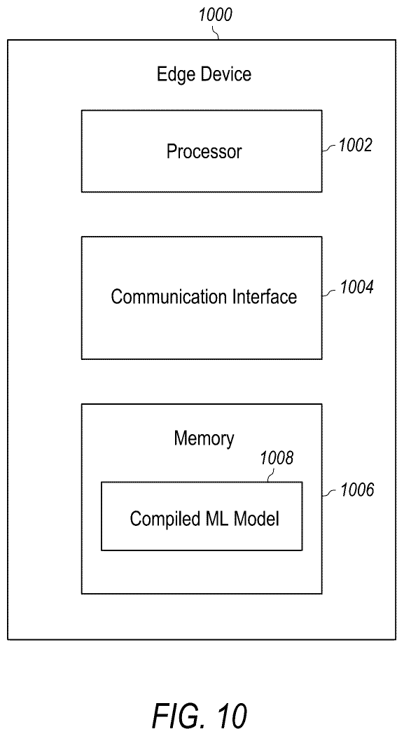

FIG. 10 illustrates an example of an edge device 1000 configured to perform machine learning inference, in accordance with aspects of the present disclosure. The edge device 1000 may be, be similar to, include, or be included in, the computing machine 500. As shown, the edge device 1000 includes a processor 1002, a communication interface 1004, and memory 1006. The processor 1002 may include one or more processors. The processor 1002 may include at least one or a microcontroller or an embedded system. The communication interface 1004 may include at least one of a network interface, a radio interface, or a wired connection interface. The communication interface 1004 allows the edge device to communicate with other device(s).

The memory 1006 stores data and/or instructions for execution by the processor 1002. The memory 1006 may include cache unit(s) and/or storage unit(s). As shown, the memory 1006 stores a compiled ML model 1008 which may be executed by the processor 1002. Executing the compiled ML model 1008 may include performing inference or, alternatively, training or testing the compiled ML model 1008.

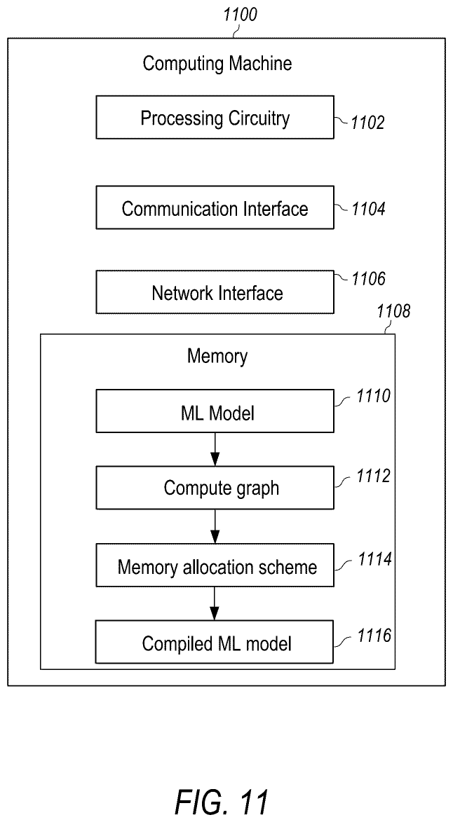

FIG. 11 illustrates an example of a computing machine 1100 configured to compile a machine learning model for execution on by an edge device, in accordance with aspects of the present disclosure. The computing machine 1100 may be, be similar to, include, or be included in, the computing machine 500. As shown, the computing machine 1100 includes processing circuitry 1102, a communication interface 1104, a network interface 1106, and memory 1108.

The processing circuitry 1102 includes one or more processors. The one or more processors may be arranged in processing unit(s), such as CPU(s) or GPU(s). The processing circuitry 1102 may include at least one a CPU or a GPU.

The communication interface 1104 may include at least one of a wired interface, a radio interface, or a network-based communication interface for communicating with the edge device 1000 to obtain data associated with operation of the edge device 1000, as described herein. The network interface 1106 may include one or more network interface cards (NICs) to configure the computing machine 1100 to communicate over a network, for example, at least one of the Internet, a Wi-Fi® network, an Ethernet network, a cellular network, or a satellite network. In some cases, the network interface 1106 includes the communication interface 1104 and/or the communication interface 1104 is a component of the network interface 1106. In some cases, the network interface 1106 is separate and distinct from the communication interface 1104.

The memory 1108 stores data and/or instructions for execution by the processing circuitry 1102. The memory 1108 may include cache unit(s) and/or storage unit(s). As shown, the memory 1108 stores an ML model 1110, a compute graph 1112, a memory allocation scheme 1114, and a compiled ML model 1116.

The compiled ML model 1116 may correspond to the compiled ML model 1008 of the edge device 1000. The compute graph 1112 may be obtained, by the processing circuitry 1102, based on the ML model 1110. The memory allocation scheme 1114 may be determined by the processing circuitry 1102 based on the ML model 1110 and the compute graph 1112. The processing circuitry 1102 may compile the ML model 1110, in accordance with the memory allocation scheme 1114, to generate the compiled ML model 1116.

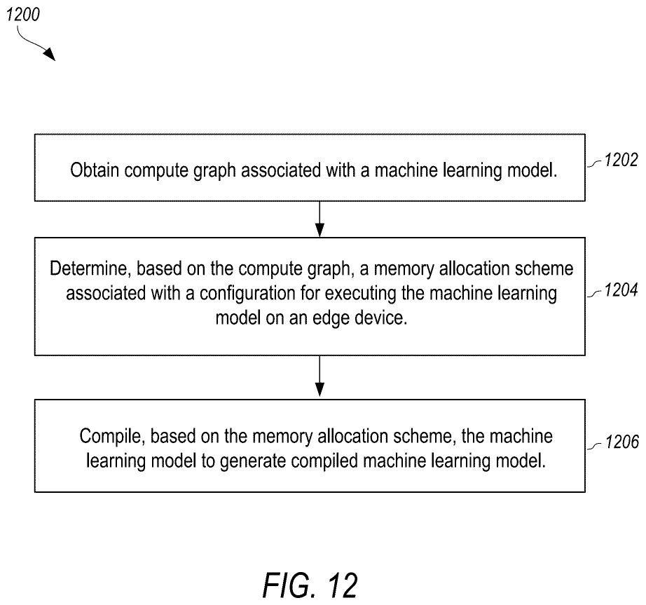

FIG. 12 is a flowchart of an example technique 1200 for compiling a machine learning component, in accordance with aspects of the present disclosure. The technique 1200 may be performed, for example, by the computing machine 1100 and/or the computing machine 500.

At block 1202, a computing machine (e.g., the computing machine 1100 and/or the computing machine 500) obtains a compute graph (e.g., the compute graph 1112) associated with a machine learning model (e.g., the ML model 1110). For example, the computing machine may obtain the compute graph by analyzing the machine learning model using processing circuitry (e.g., the processing circuitry 1102).

At block 1204, the computing machine determines a memory allocation scheme (e.g., the memory allocation scheme 1114). The memory allocation scheme may be associated with a configuration for executing the machine learning model on an edge device. In some implementations, the computing machine may obtain edge device information corresponding to the edge device and may determine the memory allocation scheme based on the edge device information. The edge device information may be indicative of a set of memory parameters associated with the edge device.

In some implementations, the computing machine may determine the memory allocation scheme by determining a set of activation blocks associated with the compute graph. Each activation block of the set of activation blocks may correspond to a compute node of the compute graph and is associated with a respective memory usage value of a set of memory usage values. The computing machine may determine the memory allocation scheme by determining a maximum memory usage value of the set of memory usage values, where the maximum memory usage value is associated with a first activation block of the set of activation blocks. The computing machine may determine the memory allocation scheme by generate, based on determining the maximum memory usage value, a modified activation block by modifying the first activation block, where the modified activation block is associated with a modified memory usage value that is less than the maximum memory usage value.

In some implementations, the computing machine obtains an optimization plan indication. The optimization plan indication may include an indication of whether to determine the memory allocation scheme according to a latency optimization model or a RAM optimization model. The computing machine may determine the memory allocation scheme based on the optimization plan indication. For example, if the optimization plan indication indicates the latency optimization model, the computing machine may determine the memory allocation scheme by applying a set of latency optimization rules. If the optimization plan indication indicates the RAM optimization model, the computing machine may determine the memory allocation scheme by applying a set of RAM optimization rules.

At block 1206, the computing machine compiles the ML model to generate a compiled ML model (e.g., the compiled ML model 1116). In some implementations, compiling the machine learning model includes generating, based on the memory allocation scheme (e.g., the memory allocation scheme 1114), a flattened compute graph. The flattened compute graph may include a sequential set of operations corresponding to the compute graph (e.g., the compute graph 1112).

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for deploying machine learning models, comprising: at least one memory; and at least one processor coupled to the at least one memory and configured to: obtain a compute graph associated with a machine learning model; determine, based on the compute graph, a memory allocation scheme associated with a configuration for executing the machine learning model on an edge device; and compile, based on the memory allocation scheme, the machine learning model to generate a compiled machine learning model.

Aspect 2. The apparatus of aspect 1, wherein, to obtain the compute graph, the at least one processor is configured to obtain user input indicative of one or more activations to be instantiated by the at least one processor.

Aspect 3. The apparatus of any of aspects 1-2, wherein the at least one processor is configured to obtain edge device information corresponding to the edge device, and wherein to determine the memory allocation scheme, the at least one processor is configured to determine the memory allocation scheme based on the edge device information.

Aspect 4. The apparatus of aspect 3, wherein the edge device information is indicative of a set of memory parameters associated with the edge device.

Aspect 5. The apparatus of any of aspects 1-4, wherein, to determine the memory allocation scheme, the at least one processor is further configured to: determine a set of activation blocks associated with the compute graph, wherein each activation block of the set of activation blocks corresponds to a compute node of the compute graph and is associated with a respective memory usage value of a set of memory usage values; determine a maximum memory usage value of the set of memory usage values, wherein the maximum memory usage value is associated with a first activation block of the set of activation blocks; and generate, based on determining the maximum memory usage value, a modified activation block by modifying the first activation block, wherein the modified activation block is associated with a modified memory usage value that is less than the maximum memory usage value.

Aspect 6. The apparatus of any of aspects 1-5, wherein the at least one processor is configured to obtain an optimization plan indication, the optimization plan indication comprising an indication to determine the memory allocation scheme according to a latency optimization model, and wherein, to determine the memory allocation scheme the at least one processor is configured to determine the memory allocation scheme according to the latency optimization model.

Aspect 7. The apparatus of any of aspects 1-6, wherein, to determine the memory allocation scheme according to the latency optimization model, the at least one processor is configured to apply a set of latency optimization rules.

Aspect 8. The apparatus of any of aspects 1-7, wherein the at least one processor is configured to obtain an optimization plan indication comprising an indication to determine the memory allocation scheme according to a random access memory optimization model, and wherein to determine the memory allocation scheme, the at least one processor is configured to determine the memory allocation scheme according to the random access memory optimization model.

Aspect 9. The apparatus of any of aspects 1-8, wherein, to determine the memory allocation scheme according to the random access memory optimization model, the at least one processor is configured to apply a set of random access memory optimization rules.

Aspect 10. The apparatus of any of aspects 1-8, wherein, to compile the machine learning model, wherein the at least one processor is configured to generate, based on the memory allocation scheme, a flattened compute graph, the flattened compute graph comprising a sequential set of operations corresponding to the compute graph.

Aspect 11. A method comprising: obtaining, by a processor, a compute graph associated with a machine learning model; determining, by the processor and based on the compute graph, a memory allocation scheme associated with a configuration for executing the machine learning model on an edge device; and compiling, by the processor and based on the memory allocation scheme, the machine learning model to generate a compiled machine learning model.

Aspect 12. The method of aspect 11, wherein obtaining the compute graph comprises obtaining user input indicative of one or more activations to be instantiated by the processor.

Aspect 13. The method of any of aspects 11-12, further comprising obtaining edge device information corresponding to the edge device, wherein determining the memory allocation scheme comprises determining the memory allocation scheme based on the edge device information.

Aspect 14. The method of aspect 13, wherein the edge device information is indicative of a set of memory parameters associated with the edge device.

Aspect 15. The method of any of aspects 11-14, wherein determining the memory allocation scheme comprises: determining a set of activation blocks associated with the compute graph, wherein each activation block of the set of activation blocks corresponds to a compute node of the compute graph and is associated with a respective memory usage value of a set of memory usage values; determining a maximum memory usage value of the set of memory usage values, wherein the maximum memory usage value is associated with a first activation block of the set of activation blocks; and generating, based on determining the maximum memory usage value, a modified activation block by modifying the first activation block, wherein the modified activation block is associated with a modified memory usage value that is less than the maximum memory usage value.

Aspect 16. The method of any of aspects 11-15, further comprising obtaining an optimization plan indication, the optimization plan indication comprising an indication to determine the memory allocation scheme according to a latency optimization model, wherein determining the memory allocation scheme comprises determining the memory allocation scheme according to the latency optimization model.

Aspect 17. The method of any of aspects 11-16, wherein determining the memory allocation scheme according to the latency optimization model comprises applying a set of latency optimization rules.

Aspect 18. The method of any of aspects 11-17, further comprising obtaining an optimization plan indication comprising an indication to determine the memory allocation scheme according to a random access memory optimization model, wherein determining the memory allocation scheme comprises determining the memory allocation scheme according to the random access memory optimization model and applying a set of random access memory optimization rules.

Aspect 19. The method of any of aspects 11-18, wherein compiling the machine learning model comprises generating, based on the memory allocation scheme, a flattened compute graph, the flattened compute graph comprising a sequential set of operations corresponding to the compute graph.

Aspect 20. The method of any of aspects 11-19, wherein compiling the machine learning model comprises generating, based on the memory allocation scheme, a flattened compute graph, the flattened compute graph comprising a sequential set of operations corresponding to the compute graph.

Aspect 19. A computer-readable medium having instructions stored thereon, that when executed by one or more processors, cause the one or more processors to perform operations according to any any of aspects 11-20.

Aspect 20. An apparatus including one or more means for performing operations according to any of aspects 11-20.

What is claimed is:

1. An apparatus for deploying machine learning models, comprising:
at least one memory; and
at least one processor coupled to the at least one memory and configured to:
obtain a compute graph associated with a machine learning model;
determine, based on the compute graph, a memory allocation scheme associated with a configuration for executing the machine learning model on an edge device; and
compile, based on the memory allocation scheme, the machine learning model to generate a compiled machine learning model.

2. The apparatus of claim 1, wherein, to obtain the compute graph, the at least one processor is configured to obtain user input indicative of one or more activations to be instantiated by the at least one processor.

3. The apparatus of claim 1, wherein the at least one processor is configured to obtain edge device information corresponding to the edge device, and wherein to determine the memory allocation scheme, the at least one processor is configured to determine the memory allocation scheme based on the edge device information.

4. The apparatus of claim 3, wherein the edge device information is indicative of a set of memory parameters associated with the edge device.

5. The apparatus of claim 1, wherein, to determine the memory allocation scheme, the at least one processor is further configured to:
determine a set of activation blocks associated with the compute graph, wherein each activation block of the set of activation blocks corresponds to a compute node of the compute graph and is associated with a respective memory usage value of a set of memory usage values;
determine a maximum memory usage value of the set of memory usage values, wherein the maximum memory usage value is associated with a first activation block of the set of activation blocks; and
generate, based on determining the maximum memory usage value, a modified activation block by modifying the first activation block, wherein the modified activation block is associated with a modified memory usage value that is less than the maximum memory usage value.

6. The apparatus of claim 1, wherein the at least one processor is configured to obtain an optimization plan indication, the optimization plan indication comprising an indication to determine the memory allocation scheme according to a latency optimization model, and wherein, to determine the memory allocation scheme the at least one processor is configured to determine the memory allocation scheme according to the latency optimization model.

7. The apparatus of claim 6, wherein, to determine the memory allocation scheme according to the latency optimization model, the at least one processor is configured to apply a set of latency optimization rules.

8. The apparatus of claim 1, wherein the at least one processor is configured to obtain an optimization plan indication comprising an indication to determine the memory allocation scheme according to a random access memory optimization model, and wherein to determine the memory allocation scheme, the at least one processor is configured to determine the memory allocation scheme according to the random access memory optimization model.

9. The apparatus of claim 8, wherein, to determine the memory allocation scheme according to the random access memory optimization model, the at least one processor is configured to apply a set of random access memory optimization rules.

10. The apparatus of claim 1, wherein, to compile the machine learning model, wherein the at least one processor is configured to generate, based on the memory allocation scheme, a flattened compute graph, the flattened compute graph comprising a sequential set of operations corresponding to the compute graph.

11. A method comprising:
obtaining, by a processor, a compute graph associated with a machine learning model;
determining, by the processor and based on the compute graph, a memory allocation scheme associated with a configuration for executing the machine learning model on an edge device; and
compiling, by the processor and based on the memory allocation scheme, the machine learning model to generate a compiled machine learning model.

12. The method of claim 11, wherein obtaining the compute graph comprises obtaining user input indicative of one or more activations to be instantiated by the processor.

13. The method of claim 11, further comprising obtaining edge device information corresponding to the edge device, wherein determining the memory allocation scheme comprises determining the memory allocation scheme based on the edge device information.

14. The method of claim 13, wherein the edge device information is indicative of a set of memory parameters associated with the edge device.

15. The method of claim 11, wherein determining the memory allocation scheme comprises:
determining a set of activation blocks associated with the compute graph, wherein each activation block of the set of activation blocks corresponds to a compute node of the compute graph and is associated with a respective memory usage value of a set of memory usage values;
determining a maximum memory usage value of the set of memory usage values, wherein the maximum memory usage value is associated with a first activation block of the set of activation blocks; and
generating, based on determining the maximum memory usage value, a modified activation block by modifying the first activation block, wherein the modified activation block is associated with a modified memory usage value that is less than the maximum memory usage value.

16. The method of claim 11, further comprising obtaining an optimization plan indication, the optimization plan indication comprising an indication to determine the memory allocation scheme according to a latency optimization model, wherein determining the memory allocation scheme comprises determining the memory allocation scheme according to the latency optimization model.

17. The method of claim 16, wherein determining the memory allocation scheme according to the latency optimization model comprises applying a set of latency optimization rules.

18. The method of claim 11, further comprising obtaining an optimization plan indication comprising an indication to determine the memory allocation scheme according to a random access memory optimization model, wherein determining the memory allocation scheme comprises determining the memory allocation scheme according to the random access memory optimization model and applying a set of random access memory optimization rules.

19. The method of claim 11, wherein compiling the machine learning model comprises generating, based on the memory allocation scheme, a flattened compute graph, the flattened compute graph comprising a sequential set of operations corresponding to the compute graph.

20. A computer-readable medium having instructions stored thereon, that when executed by one or more processors, cause the one or more processors to:
obtain a compute graph associated with a machine learning model;
determine, based on the compute graph, a memory allocation scheme associated with a configuration for executing the machine learning model on an edge device; and
compile, based on the memory allocation scheme, the machine learning model to generate a compiled machine learning model.
